(19) United States
(12) Patent Application Publication
(10) Pub. No.: US 2015/0330904 A1
(43) Pub. Date: Nov. 19, 2015

(54) COLORMETRIC SENSOR DETECTING ANALYTES WITH VISUAL EXAMINATION

(71) Applicant: RESEARCH & BUSINESS FOUNDATION SUNGKYUNKWAN UNIVERSITY, Suwon-si (KR)

(72) Inventors: Jung Heon LEE, Seoul (KR); Jun Hyuk HEO, Suwon-si (KR); Hui Hun CHO, Suwon-si (KR)

(73) Assignee: RESEARCH & BUSINESS FOUNDATION SUNGKYUNKWAN UNIVERSITY, Suwon-si (KR)

(21) Appl. No.: 14/687,021

(22) Filed: Apr. 15, 2015

(30) Foreign Application Priority Data
May 15, 2014 (KR) 10-2014-0058360

(51) Int. Cl. G01N 21/78; G01N 21/80

(52) U.S. Cl. CPC G01N 21/78; G01N 21/783; G01N 21/80

(57) ABSTRACT

Provided is a colorimetric sensor whose color is changed from an A color to a B color after being exposed to analytes and which adds a dye or pigment complementing the A or B color so as to induce the color change from a black color to another color thereby maximizing a color contrast effect. The colorimetric sensor according to embodiments of the present invention includes a color change detecting part in which an indicator of which a color is changed according to presence and absence of the analytes and a dye which complements the color of the indicator are mixed, wherein the analytes are detected using a color change of the color change detecting part.

### CROSS-REFERENCE TO RELATED APPLICATION

This application claims priority to and the benefit of Korean Patent Application No. 10-2014-0058360, filed on May 15, 2014, the disclosure of which is incorporated herein by reference in its entirety.

### BACKGROUND

1. Field of the Invention

The present invention relates to a colorimetric sensor, and more particularly, to a method of detecting analytes using the colorimetric sensor.

2. Discussion of Related Art

An analysis method capable of quantitatively and qualitatively analyzing harmful gases and harmful chemical substances at an industrial site or an accident scene is required. In particular, even though an accident occurs in a closed space, it is difficult to preserve the site. So, a direct and rapid analysis method is essential. A simple analysis method with high facility and precision is required to detect various harmful gases generated at an underground space, an industrial space or the like. Also, an analysis method which may be applied to various samples such as a gas state or liquid state sample and a blood sample and thus may be used in a medical field, a forensic science field and an industrial field is required. Currently, a titration method, a spectroscopic analysis method, an electrochemical analysis method, a chromatography are used for the purposes. The titration method uses simple devices, but has low detection sensitivity. To react with and detect the harmful gases, other methods using complicated chemical compounds and including expensive and complicated devices are required. Therefore, a new device and method for detection of harmful substances and gases, such as biochemical molecules or tagged markers, biological basic unit living organisms such as cells, germs, viruses and bacteria, and heavy metals, which allow rapid and on site use, with high sensitivity reliability is required.

To solve such a problem, a colorimetric sensor is used. Among various methods which may be used in a chemical sensing, a colorimetric technology has an advantage in that a user's vision may be used without use of a large-sized device.

A colorimetric sensor array has high sensitivity but can be prepared at a low cost. So it is known as a useful method of detecting and confirming various kinds of analytes. To detect the existence multiple analytes simultaneously, colorimetric sensor array with about 36 kinds of pigments or dyes (base indicators, acid indicators, vapochromic, and metal salts) printed on substrates such as polyethylene terephthalate (PET) can be used. However, since the color of multiple pigments and dyes changes at the same time, it is very difficult to know what substance reacts with naked eyes.

As illustrated in FIG. 1, when a normal colorimetric sensor is exposed to an analyte, its color changes. However, since the color change of a colorimetric sensor occurs between two chromatic colors, it is difficult to notice the occurrence and amount of color change. Furthermore, when multiple colorimetric indicators are aligned as arrays for multiplexed analysis, the coexistence and color change of multiple indicators make it very difficult to immediately notify the existence of analytes.

The present invention is aimed to improve the color perception of conventional colorimetric sensors.

### PRIOR ART DOCUMENTS

### Patent Documents

(Patent document 1) U.S. Pat. No. 7,449,146 B2 (Nov. 11, 2008)
(Patent document 2) Korean Patent No. 10-11208659 (Dec. 5, 2012)

### Non-Patent Documents

(Non-patent document 1) K. Suslick et al., Nanoscale, 2011, 3, 1971-1973

### SUMMARY OF THE INVENTION

The present invention is directed to a colorimetric sensor which solves the problem most conventional colorimetric sensors have on color perception. It is difficult to immediately be aware of the color change of a colorimetric sensor after reaction, because most conventional colorimetric sensors have colors (chromatic color) before and after reaction with analytes.

Also, the present invention is directed to a colorimetric sensor whose color changes from a chromatic color to an achromatic color or vice versa, so that a change in the color change of the sensor can clearly indicated.

Thus, the present invention is directed to a colorimetric sensor by which the presence and absence of an analyte can immediately and precisely be perceived.

According to an aspect of the present invention, there is provided a colorimetric sensor detecting analytes through visual examination, including a color change detecting part. This color change detecting part includes an indicator, whose color changes after reaction with an analyte, and a dye whose color is complementary to the color of indicator. The detection is made through the color change occurring at the colorimetric sensor composed of both an indicator and its complementary colored dye.

The dye which complements the color of the indicator may be prepared by combining dyes having three primary colors of magenta, yellow and cyan.

The colorimetric sensor may detect analytes from a sample in a liquid state or an aqueous solution state, may detect analytes from a sample in a gas state, and may detect analytes from a sample in a solid state.

According to another aspect of the present invention, there is provided a colorimetric sensor detecting analytes with a visual examination, including a plurality of color change detecting parts. Each color change detecting part includes an indicator, whose color changes after reaction with an analyte, and a dye whose color is complementary to the color of indicator. The detection is made through the color changes occurring at multiple color change detecting parts.

The colorimetric sensor may further include an identification part configured to determine whether the color change occurs in the color change detecting part; and an output part configured to output a status change when the color change is detected by the identification part. The identification part may detect whether the color change of the color change detecting part occurs.

The colorimetric sensor may be used as a medical bio-sensor, a heavy metal sensor, an organic molecule sensor and a chemical molecule sensor.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 illustrates a state in which a color of a color detecting part of a conventional colorimetric sensor is changed;

FIG. 2 illustrates a color code showing a complementary relationship.

FIG. 3 is a view illustrating a state in which an achromatic color is formed using a complementary color;

FIG. 4 is a cross-sectional view illustrating a structure of a colorimetric sensor in accordance with one embodiment of the present invention;

FIG. 5 illustrates a state in which a color of the colorimetric sensor in accordance with one embodiment of the present invention is changed before and after a reaction with an analyte.

FIG. 6A illustrates a color change of a bromocresol purple (BCP) according to a change in pH, and FIG. 6B illustrates an UV vis spectrum of the BCP;

FIG. 7A illustrates a color change of a yellow dye according to the change in pH, and FIG. 7B illustrates an UV vis spectrum of the yellow dye;

FIG. 8 illustrates a color change when a mixed solution of the BCP and the yellow dye is prepared and HCl as the analyte is detected;

FIG. 9A illustrates a color change of a methyl violet (MV) according to the change in pH, and FIG. 9B illustrates an UV vis spectrum of the MV;

FIG. 10A illustrates a color change of a green dye according to the change in pH, and FIG. 10B illustrates an UV vis spectrum of the green dye; and

FIG. 11 illustrates a color change when a mixed solution of the MV and the green dye is prepared and HCl as the analyte is detected.

### DETAILED DESCRIPTION OF EXEMPLARY EMBODIMENTS

Description of the exemplary embodiment of the present invention to provide a basic understanding of one or more embodiments provides a simplified description. This section is neither a comprehensive overview of all possible embodiments nor intended to identify the key elements all of the elements or to cover the range of all embodiments. After that the only purpose of which is presented as a simplified introduction of more detailed description in the form of one or more embodiments is to provide a concept.

Unlike the related art, the present invention may change a chromatic color into an achromatic color or vice versa, may grasp a color change at a glance, and thus may allow an operator to immediately recognize the existence of an analyte.

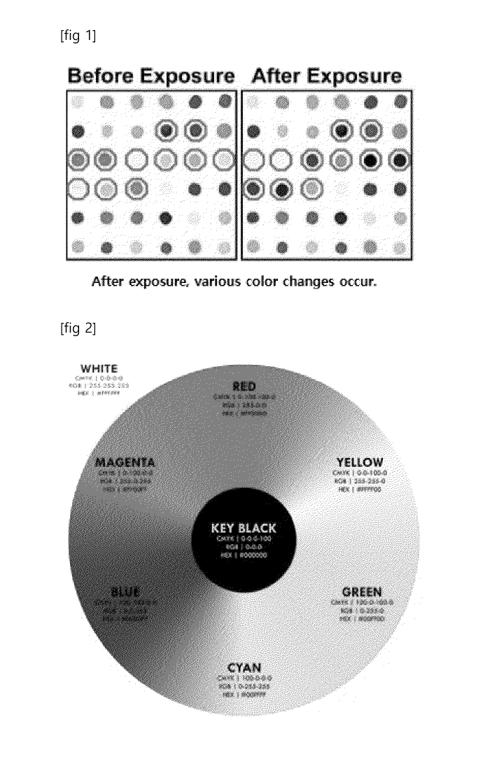

In a conventional colorimetric sensor, since it has a color in both cases of before and after the color change, it is difficult to immediately grasp whether the color is changed. FIG. 1 illustrates the conventional colorimetric sensor, wherein the colorimetric sensor is exposed to the analyte, and thus the color change occurs, but it may be understood that it is difficult to grasp an indicator, in which the color change occurs, at a glance, and thus it is difficult to grasp what kind of analyte exists at a glance.

A colorimetric sensor in accordance with one embodiment of the present invention includes a color change detecting part in which an indicator of which a color is changed according to presence and absence of the analytes and a dye complementing a color of the indicator are mixed.

In the specification, the “color change detecting part” is a part which detects the color change and includes the indicator. A plurality of color change detecting parts may be arranged in an array manner. An example of FIG. 1 illustrates the color change detecting parts having a 6×6 array.

The present invention may include any kind of indicator of which a color is changed according to the presence and absence of the analyte. For example, a pH indicator is a representative indicator. The color of the indicator is changed according to a change of pH, a chemical reaction with the analyte or light from the analyte, and presence and absence of harmful substances, gases, biochemical molecules, tagged markers, cells, germs, viruses, bacteria and heavy metals.

The dye may be referred to as a pigment. The dye has its own color regardless of the presence and absence of the analyte. In the present invention, the dye having a color which complements a color of the indicator is used. This is because, when two colors which complement each other are mixed, it has a black color, which is an achromatic color, due to a complementary relationship. This is caused by that the mixed indicator absorbs most light within a visible light range.

FIG. 2A illustrates a color code showing a complementary relationship, and FIG. 2B is a view illustrating a state in which an achromatic color is formed using a complementary color.

In accordance with one embodiment of the present invention, the dye which complements the color of the indicator may be manufactured by combining dyes having three primary colors of magenta, yellow and cyan. Therefore, the dye which complements any color of the indicator may be manufactured.

In the present invention, the indicator and the dye having the colors which complement each other are mixed, such that the color change from a chromatic color to an achromatic color or the vice versa, when the analyte is detected, and thus presence and absence of the analyte may be easily recognized with a visual examination.

The colorimetric sensor in accordance with one embodiment of the present invention detects the analyte using the color change of the color change detecting part. For example, such a detecting operation may be performed by a chemical reaction between the indicator and the analyte. The chemical reaction is not affected by environmental factors such as temperature and humidity, and may be easily detected in real time using advantages such as fast reaction time, reactivity with the analyte, and mobility.

The indicator may be selectively used according to a kind of the analyte. In this case, the dye which complements the color of the indicator is used. As described above, the dye which complements the color of the indicator may be manufactured using the dyes having the three primary colors.

The colorimetric sensor in accordance with one embodiment of the present invention may detect the analyte from a sample in a liquid state or an aqueous solution state, and may also detect the analyte from a sample in a gas state.

Meanwhile, the colorimetric sensor in accordance with an additional embodiment of the present invention may detect the analyte using light emitted from the analyte. For example, in the case in which a water pollution level is measured, if the analyte emits red light, the water is clean, and if the analyte emits green light, it means that a substance desired to be detected is contained in the water.

In the case of the colorimetric sensor which detects the analyte from the light emitted from the analyte, a color of the light which complements the color of the indicator may be formed by combining three primary colors of light which are red, green and blue colors.

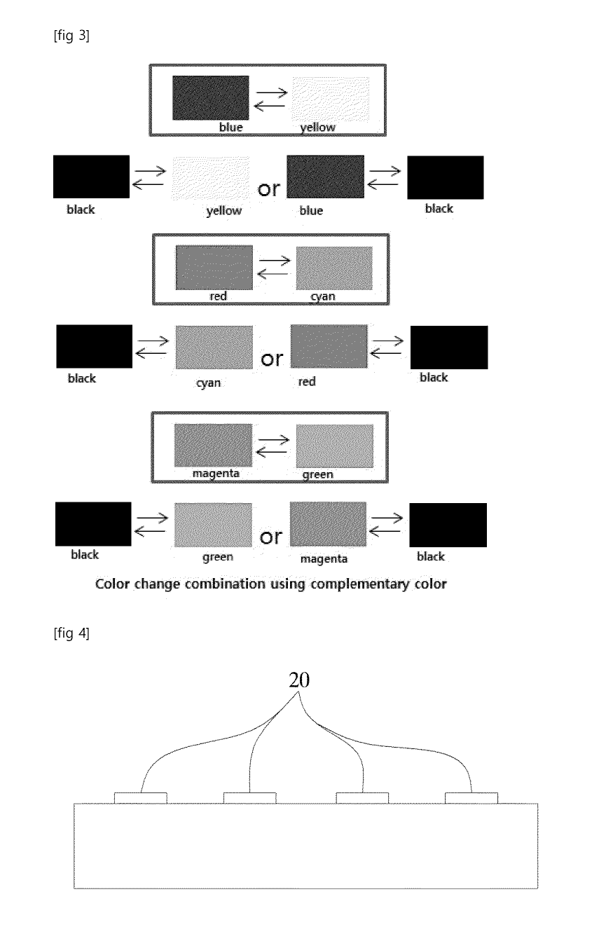

FIG. 3 illustrates a colorimetric sensor in accordance with an additional embodiment of the present invention. As illustrated in FIG. 3, the colorimetric sensor includes a substrate 10, and a color change detecting part 20 which is disposed on the substrate 10.

The substrate 10 is not specifically limited, and a PET film substrate is typically used. The substrate is just an exemplary embodiment, and various types such as a dip stick and a micro-flow device may be used as the substrate.

At the color change detecting part 20, the indicator of which the color is changed according to the presence and absence of the analyte and the dye which complements the color of the indicator are mixed. This has been described above in detail, and thus the description thereof will be omitted. The color change detecting part 20 is illustrated to protrude upward, but is not limited thereto. The color change detecting part 20 may be built in the substrate and may be disposed to have a smooth surface.

As illustrated in FIGS. 3 and 4, a plurality of the color change detecting parts may be provided. In this case, each color change detecting part may detect different analytes using each color change.

FIG. 4 illustrates an array of the color change detecting parts of the colorimetric sensor in accordance with additional embodiment of the present invention, and also illustrates a state before and after a reaction with the analyte. As illustrated in FIG. 4, it may be understood that the color is changed from the achromatic color to the chromatic color, and thus it is possible to easily detect the analyte at a glance.

Also, the colorimetric sensor in accordance with additional embodiment of the present invention may include an identification part which determines whether the color change occurs in the color change detecting part, and an output part which outputs a status change when it is determined by the identification part that the color change occurs.

The identification part (not shown) is a part which determines whether the color change occurs in the color change detecting part. For example, in the case of the colorimetric sensor using the change of pH, the identification part may be a pH meter which determines whether pH is changed. A pH change of the color change detecting part is detected by the pH meter, and thus it is possible to determine whether the color change occurs.

Meanwhile, when the color change occurs in the colorimetric sensor (i.e., when the color change occurs in the color change detecting part), it may be informed to a user through a separate output part. In this case, the output part may be a speaker or an alarm device (e.g., a display device, an alert device). This is just an exemplary embodiment, and all kinds of output signals such as an electric signal, an electronic signal, a sound wave and a pressure may be used.

Hereinafter, the present invention will be additionally described through an actual experimental example. In the actual experimental example, a pH indicator is used as the indicator. In the below embodiments, the analyte is detected through the color change of the pH indicator.

### First Embodiment

In the first embodiment, a bromocresol purple (BCP) was used as the pH indicator, and a yellow dye was used as the dye.

The BCP has a transition pH range of 5.2 to 6.8. The BCP has a blue-violet color at a range more than the transition pH range, and has a yellow color at a range less than the transition pH range. In the case in which this indicator is mixed with a yellow dye at a pH of 8.66 and a volume ratio of 4:1, it has the black color due to the complementary relation, because the BCP has the blue-violet color, and the yellow dye has a green-based yellow color.

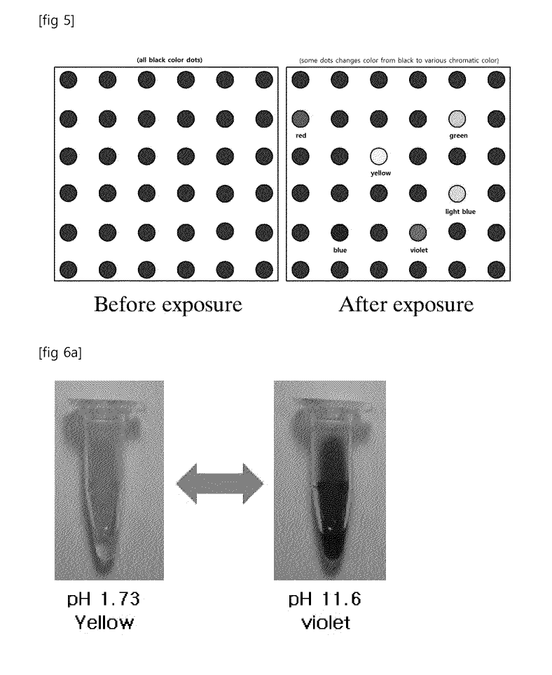

FIG. 6A illustrates the color change of the BCP according to a change in pH, and FIG. 6B illustrates an UV vis spectrum of the BCP. As illustrated in FIGS. 6A and 6B, it was confirmed that the color of the BCP was changed from the yellow color to the blue-violet color (violet color) according to the change of pH, and the BCP absorbed a light wavelength of about 400 nm at a pH of 1.73 and a light wavelength of about 600 nm at a pH of 11.6 in a visible light wavelength range of 400 to 700 nm, when an UV-vis was measured.

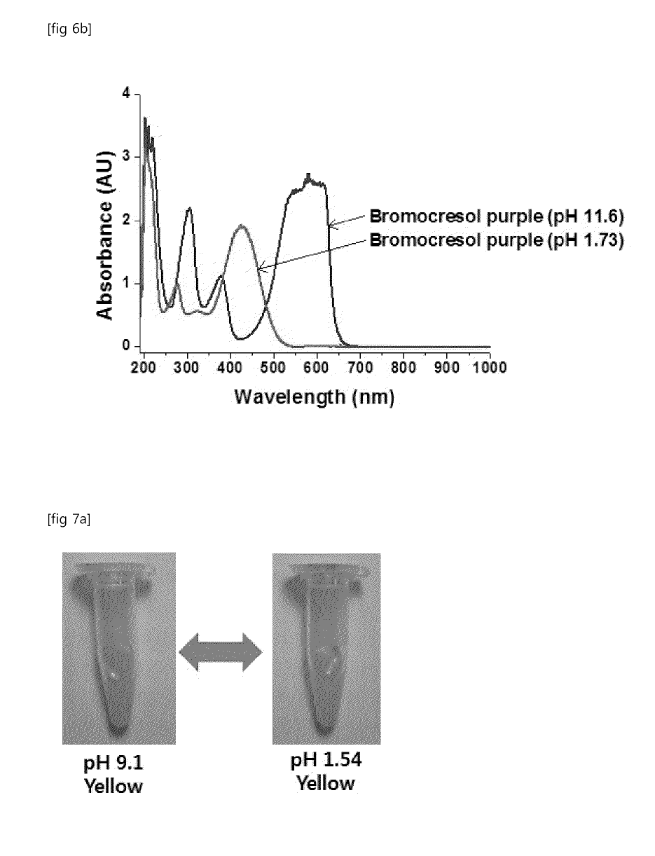

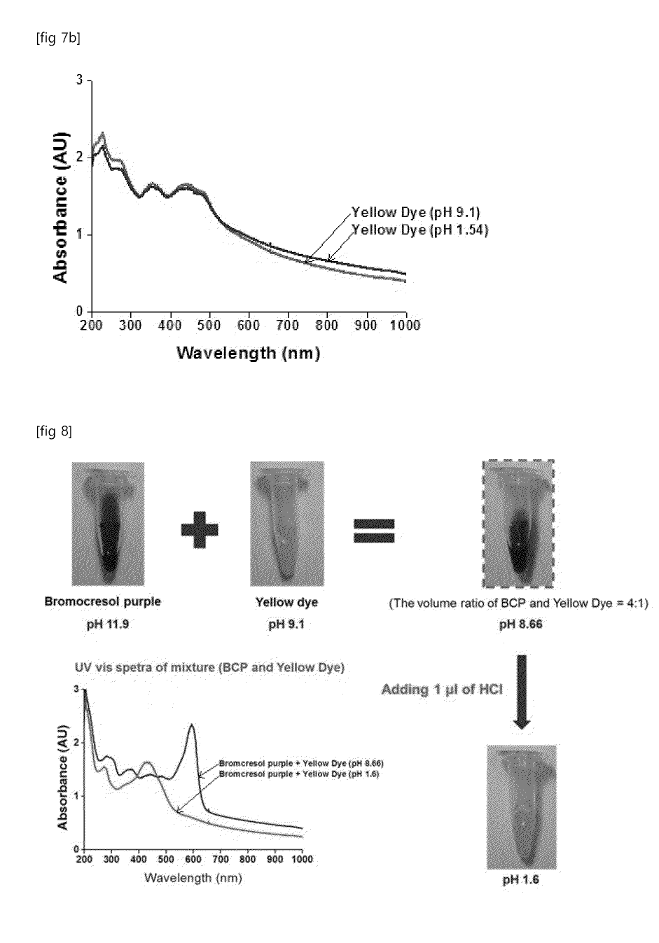

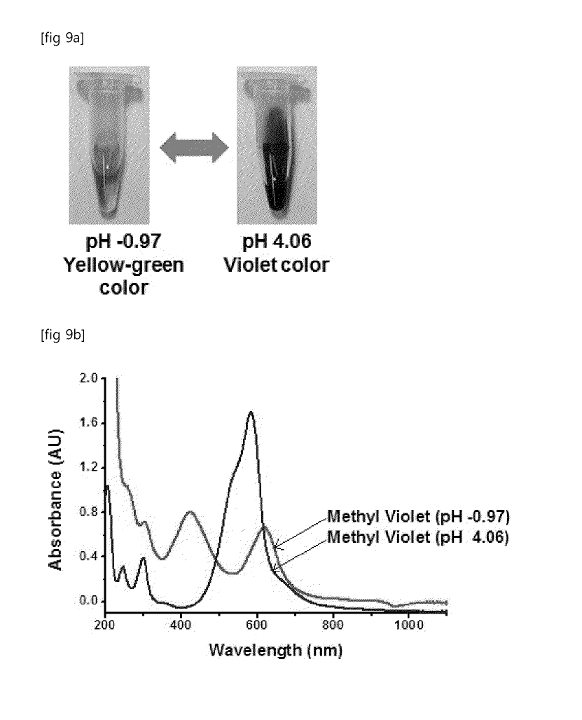

FIG. 7A illustrates a color change of the yellow dye according to the change in pH, and FIG. 7B illustrates an UV vis spectrum of the yellow dye. As illustrated in FIGS. 7A and 7B, it was confirmed that the color of the yellow dye was not changed according to the change of pH, and the yellow dye was not changed according to the pH in the visible light wavelength range of 400 to 700 nm, as a result of the measurement of the UV-vis.

In FIG. 8, it was confirmed that, when the BCP and the yellow dye were mixed at the volume ratio of 4:1 to form a black mixed solution, and then HCl as the analyte was added thereto, the black color was changed from the black color to the yellow color according to the change of pH. That is, it was possible to easily detect presence and absence of the HCl with a visual examination.

### Second Embodiment

In the second embodiment, a methyl violet (MV) was used as the pH indicator, and a green dye was used as the dye.

The MV has a transition pH range of 0 to 1.6. The MV has a blue-violet color at a range more than the transition pH range, and has a yellow green color at a range less than the transition pH range. In the case in which this indicator is mixed with a green dye at a pH of 8.31 and a volume ratio of 4:1, it has the black color due to the complementary relation, because the MV has the blue-violet color, and the green dye has a bright green color.

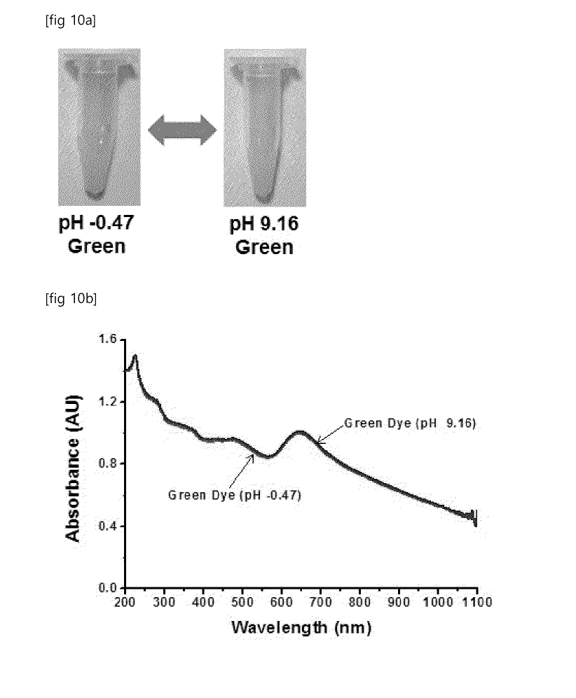

FIG. 9A illustrates a color change of the MV according to the change in pH, and FIG. 9B illustrates an UV vis spectrum of the MV. As illustrated in FIGS. 9A and 9B, it was confirmed that the color of the MV was changed from the yellow green color to the blue-violet color (violet color) according to the change of pH, and the MV absorbed a light wavelength of about 430 nm and 630 nm at a pH of −0.97 and a light wavelength of about 580 nm at a pH of 4.06 in a visible light wavelength range of 400 to 700 nm, when an UV-vis was measured.

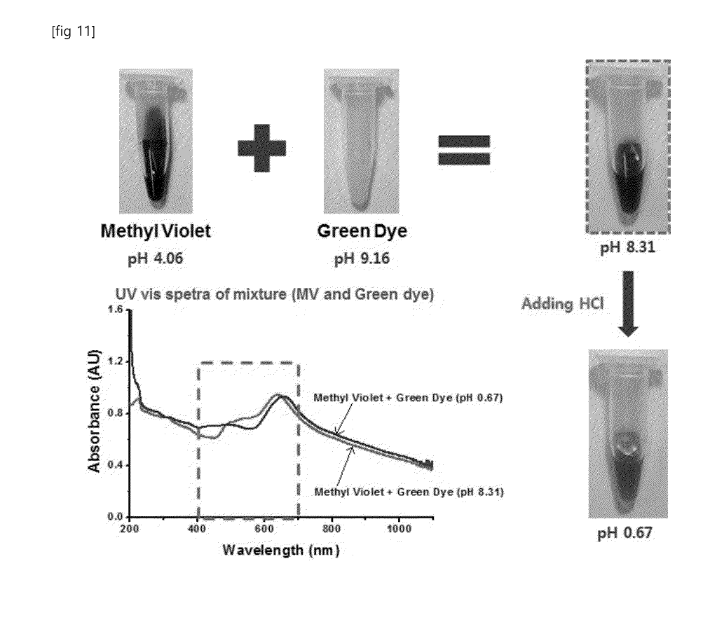

FIG. 10A illustrates a color change of the green dye according to the change in pH, and FIG. 10B illustrates an UV vis spectrum of the green dye. As illustrated in FIGS. 10A and 10B, it was confirmed that the color of the green dye was not changed according to the change of pH, and the green dye was not changed according to the pH in the visible light wavelength range of 400 to 700 nm, as a result of the measurement of the UV-vis.

In FIG. 11, it was confirmed that, when the MV and the green dye were mixed at the volume ratio of 4:1 to form a black mixed solution, and then HCl as the analyte was added thereto, the black color was changed from the black color to the green color according to the change of pH. That is, it was possible to easily detect presence and absence of the HCl with a visual examination.

The colorimetric sensor of the present invention can be changed from a chromatic color to an achromatic color or vice versa, such that a change in the color thereof is clearly indicated. Therefore, it is possible to immediately confirm the presence and absence of the analyte.

Also, the present invention can manufacture the sensor in which the color change from the achromatic color such as a block color to the chromatic color occurs, and thus can provide the colorimetric sensor which is clearly turned on and off.

The description of the above-described embodiments is provided to enable those skilled in the art to use or implement the present invention. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be construed in the widest scope consistent with the principles and novel features disclosed herein.

1. A colorimetric sensor detecting analytes with a visual examination, comprising:
a color change detecting part in which an indicator of which a color is changed according to presence and absence of the analytes and a dye which complements the color of the indicator are mixed,
wherein the analytes are detected using a color change of the color change detecting part from an achromatic color to a chromatic color.

2. The colorimetric sensor of claim 1, wherein the dye which complements the color of the indicator is manufactured by combining dyes having three primary colors of magenta, yellow and cyan.

3. The colorimetric sensor of claim 1, wherein the colorimetric sensor detects the analytes from a sample in a liquid state or an aqueous solution state.

4. The colorimetric sensor of claim 1, wherein the colorimetric sensor detects the analytes from a sample in a gas state.

5. The colorimetric sensor of claim 1, wherein the colorimetric sensor detects the analytes from a sample in a solid state.

6. A colorimetric sensor detecting analytes with a visual examination, comprising:
a plurality of color change detecting parts in which an indicator of which a color is changed according to presence and absence of the analytes and a dye which complements the color of the indicator are mixed,
wherein the different analytes are detected using a color change of each color change detecting part from an achromatic color to a chromatic color.

7. The colorimetric sensor of claim 6, further comprising an identification part configured to determine whether the color change occurs in the color change detecting part; and an output part configured to output a status change when the color change is detected by the identification part.

8. The colorimetric sensor of claim 7, wherein the identification part detects whether the color change of the color change detecting part occurs.

9. The colorimetric sensor of claim 6, wherein the dye which complements the color of the indicator is manufactured by combining dyes having three primary colors of magenta, yellow and cyan.

10. The colorimetric sensor of claim 1, wherein the colorimetric sensor is used as a medical bio-sensor, a heavy metal sensor, an organic molecule sensor and a chemical molecule sensor.
